(19) United States
(12) Patent Application Publication
(10) Pub. No.: US 2009/0114689 A1
(43) Pub. Date: May 7, 2009

(54) Removable storage tub apparatus for a marine vessel

(76) Inventors: Richard W. Hord, Kissimmee, FL (US); Scott J. Mills, Kissimmee, FL (US); Gene Gilbert, Kissimmee, FL (US)

Correspondence Address: William M. Hobby, III, 157 E. New England Avenue, #375, Winter Park, FL, 32789, US

(21) Appl. No.: 11/982,696

(22) Filed: Nov. 5, 2007

(51) Int. Cl. B63B 19/12; B60R 7/00

(52) U.S. Cl. 224/484; 114/201 R

(57) ABSTRACT

A removable storage tube for a marine vessel includes a hatch frame shaped to fitted in a hatch opening in a marine vessel. The hatch frame has a plurality of spaced downwardly angled notches spaced around the interior edge of the frame. A tub has an open top and a rim portion around the open top and is shaped to fit into the hatch frame. The tub has a plurality of attachment lugs on the rim portion, each lug has a pair of downwardly converging exterior sides sized to wedge into one of the hatch frame notches. Each hatch frame notch has a pair of downwardly converging interior sides, each having an outwardly angled exterior edge while each tub lug has a pair downwardly converging exterior sides each having an outwardly angled exterior edge sized to wedge into a hatch frame notch so that a hatch tub is removably mounted in a marine vessel hatch. The hatch frame has a hatch door hingedly attached thereto for closing the hatch with or without the storage tub therein.

### BACKGROUND OF THE INVENTION

The present invention relates to a removable storage tub for a marine vessel and especially to a storage tub that removably locks to a hatch frame having a hinged door for closing the hatch in the marine vessel.

Hatch and port assemblies for marine vessels are well known and are commercially available. Port assemblies are installed in the side of a vessel while hatch assemblies are typically installed in the deck of a marine vessel or any generally horizontally surface. Port assemblies are typically hinged inward while hatch assemblies typically open outwardly. A marine vessel hatch is commonly used to pass individual or marine paraphernalia through an opening in the deck.

A hatch opening normally has a hatch frame mounted in the deck of a ship or in the roof of a floor of a building or in an aircraft and has a cover. Hatch sometimes refers to the cover for the opening.

The present invention relates to a removable storage tub for a marine vessel having a hatch opening having a hatch frame shaped to be fitted in the hatch opening. The hatch frame is sized for a storage tub to be inserted into the hatch frame and hatch opening and which allows a hatch cover to be attached thereover. This allows the hatch storage tub to be quickly inserted, fully loaded, with stored materials, and to be rapidly removed as desired.

### SUMMARY OF THE INVENTION

A removable storage tub for a marine vessel includes a hatch frame shaped to fit in a hatch opening in a marine vessel. The hatch frame has a plurality of spaced, downwardly angled, notches spaced around the interior edge of the frame. The tub has an open top and a rim portion around the open top and is shaped to fit into the hatch frame. The tub has a plurality of attachment lugs on the rim portion, with each lug having a pair of downwardly converging exterior sides sized to wedge into one of the hatch frame notches. Each hatch frame notch has a pair of downwardly converging interior sides, each having an outwardly angled exterior edge while each tub lug has a pair downwardly converging exterior sides each having an inwardly angled exterior edge sized to wedge into a hatch frame notch so that a hatch tub is removably mounted in a marine vessel hatch. The hatch frame has a hatch door hingedly attached thereto for closing the hatch with or without the storage tub therein.

### BRIEF DESCRIPTION OF THE DRAWINGS

Other objects, features, and advantages of the present invention will be apparent from the written description and the drawings in which:

FIG. 1 is a perspective view of the hatch frame having a removable storage tub therein in accordance with the present invention;

FIG. 2 is a cutaway perspective of the portion of the storage tub of FIG. 1;

FIG. 3 is a cutaway perspective view of the portion of the hatch frame and cover;

FIG. 4 is a sectional exploded view of the storage tub and hatch frame; and

FIG. 5 is a cutaway elevation of the locking lugs and notches of the present invention.

### DESCRIPTION OF THE PREFERRED EMBODIMENT

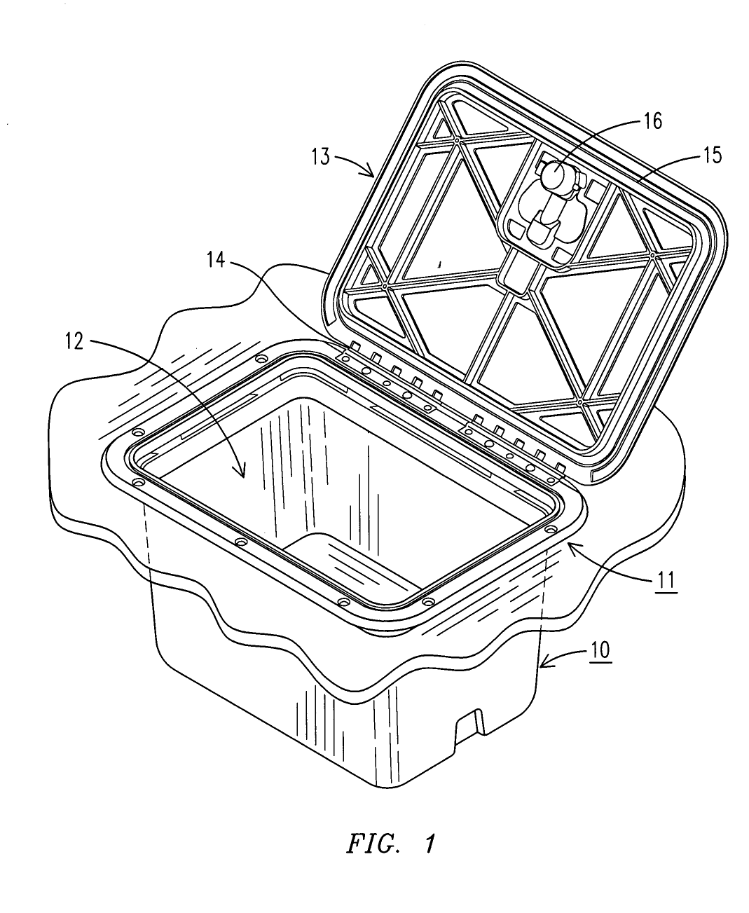

Referring to the drawings, FIGS. 1 through 5, a storage tub 10 is shown removably attached to a hatch frame in a hatch opening 12. The hatch frame 11 has the hatch cover 13 attached thereto with a hinge 14. The cover 13 may have a seal 15 for sealing the cover over the hatch opening 12 to the hatch frame 11. Hatch cover 13 also may have a lock 16 which can lock the hatch cover 13 in a closed position either to or through the tub 10.

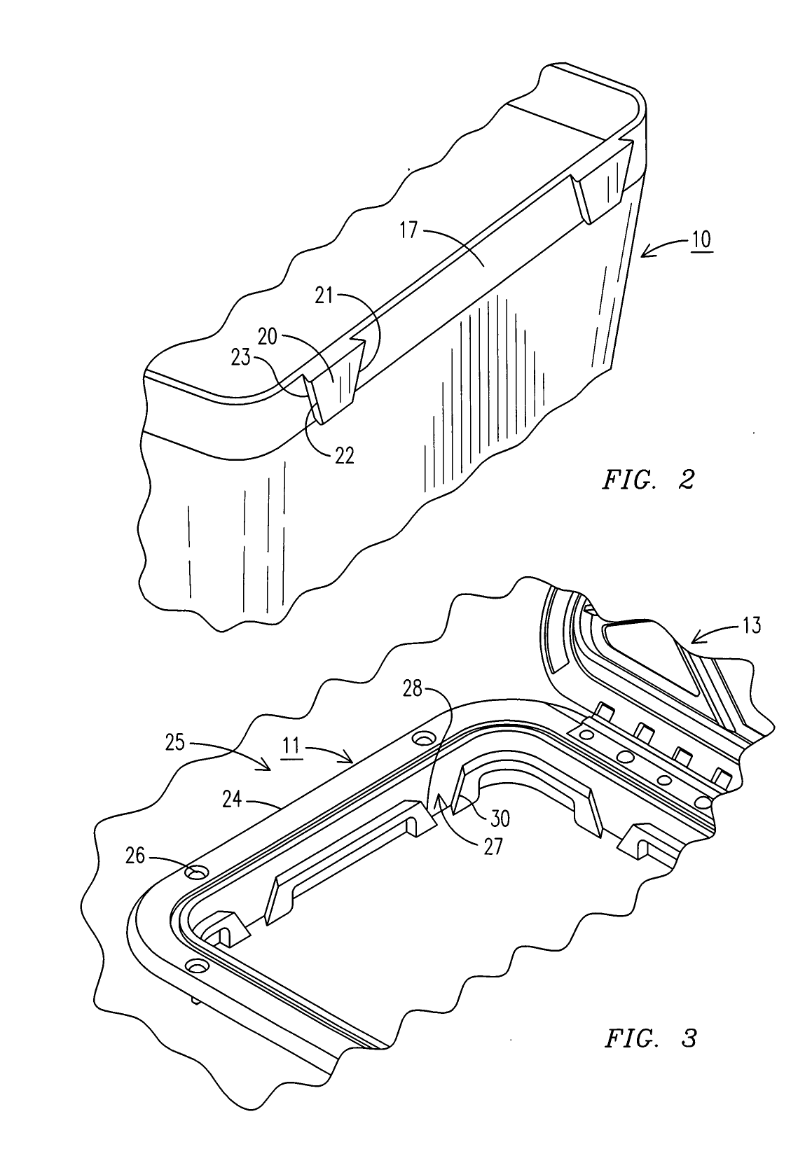

The tub 10, as seen in FIG. 2, has a reinforcing rim 10 around the open top 18 and has a plurality of attaching lugs 20 positioned around the rim 17. There may be two locking lugs 20 on each side of the generally rectangular tub 10 but the tub can have as many lugs as desired. Each lug 20 has a pair of inwardly angled sides 21 and 22 and has an inwardly angled edge 23.

The hatch frame 11, as more clearly see in FIG. 3, has a periphery flange 24 for riding on the surface 25 of a vessel and has a plurality of holes 26 for attaching the frame directly to the surface 25 of the vessel. In the inside of the frame 11 are a plurality of notches 27 each having a pair of downwardly angled sides 28, with each side 28 having an inwardly angled edge 30. The notch 27 is sized for receiving the lug 20 of the tub 10 and each lug is aligned for fitting into a matching notch 27 on the frame 11. The angled sides 20 and 21 of the lug 20 are spaced to exactly fit between a notch 27 sides 28 and the inwardly edge of the lug 20 sides 20 and 21 are angled inwardly towards the tub rim to exactly match the angled edges 30 of the notch sides 28 to lock the lugs in the notches, as more clearly seen in FIG. 5. The lugs 20 edges 21 and 23 can have a radius tip 31.

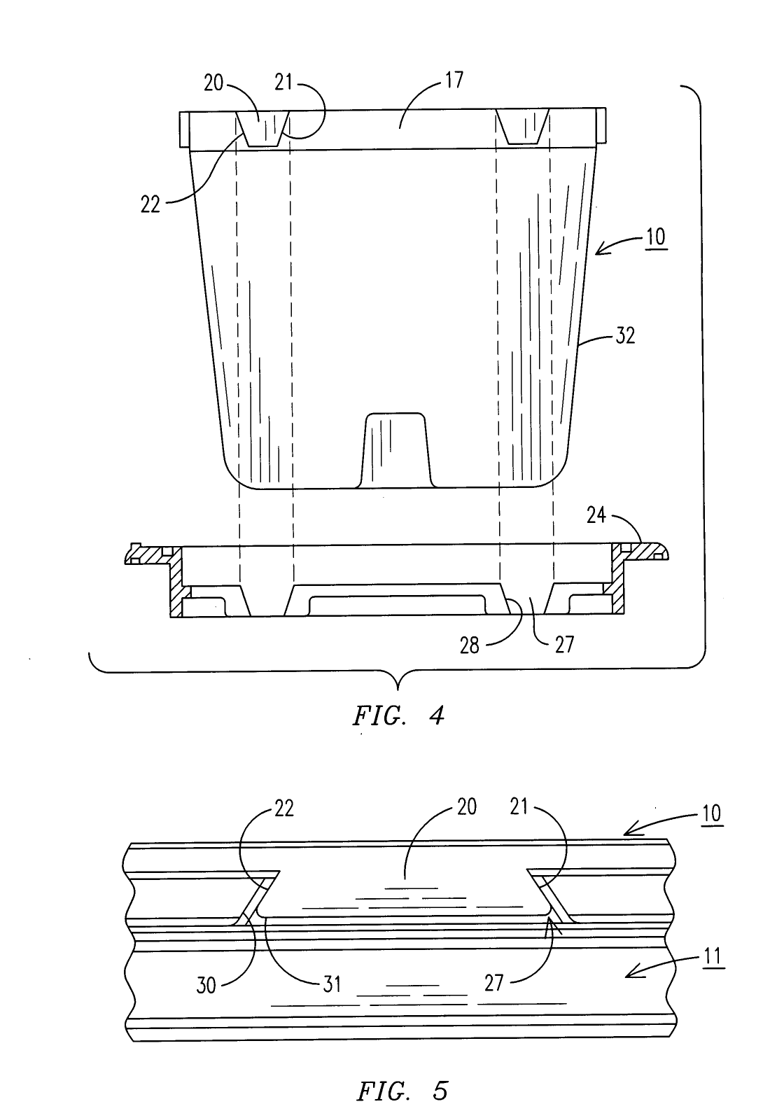

In operation, the tub 10, loaded or unloaded, can be inserted into the hatch opening 12 through the hatch frame 11, as seen in FIG. 4, with each lug 20 appropriately aligned to fit into each notch 27 with both the angled sides and oppositely angled edges engaging to lock the tub in place, as seen in FIG. 1. The tub 10 has angled sides 32 which guides the tub into the frame 11 opening to guide the lugs 20 into the notches 27. Two lugs 20 on each side of the tub 10 or two lugs on each end of the generally rectangular tub 10 permanently lock the tub in place when the tub is dropped into the hatch. In addition, the tub can be easily removed simply by lifting the tub out of the hatch frame. Once the tub is inserted, the hatch door 13 can be closed on the hinge 14 and locked to seal the tub in place and can be easily opened to remove the tub.

It should be clear at this time that a removably storage tub for a marine vessel has been provided which easily locks itself into place through the hatch frame. The hatch frame door can then be closed over the tub. Thus, the hatch can be utilized for storage of items in a tub or can be removed to leave the hatch open for the placement or removal of items through the hatch opening. Accordingly, the present invention is not to be construed as limited to the forms shown which are to be considered illustrative rather than restrictive.

We claim:

1. A removable storage tub for a marine vessel comprising:
a hatch frame shaped to be fitted in a hatch opening in a marine vessel, said hatch frame having a plurality of spaced downwardly angled notches spaced around the interior thereof;
a tub having an open top and a rim portion around said open top, said tub being shaped to fit into said hatch frame and having a plurality of attachment lugs on said rim portion, each said lug having an angled sides and being aligned and sized to engage one and wedge into one said hatch frame notch when said tub is inserted into said hatch frame to thereby lock said tub to said hatch frame; whereby a hatch tub is removably mounted in a marine vessel hatch.

2. The removable storage tub for a marine vessel in accordance with claim 1 in which each said hatch frame notch has a pair of downwardly converging interior sides.

3. The removable storage tub for a marine vessel in accordance with claim 2 in which each said tub lug has a pair of downwardly converging exterior sides sized to wedge into one said hatch frame notch.

4. The removable storage tub for a marine vessel in accordance with claim 3 in which each said hatch frame notch pair of downwardly converging interior sides each has an inwardly angled interior side edge.

5. The removable storage tub for a marine vessel in accordance with claim 4 in which each said tub lug pair of downwardly converging exterior sides each has an outwardly angled exterior edge sized to wedge into one said hatch frame notch.

6. The removable storage tub for a marine vessel in accordance with claim 5 in which said tub has a generally rectangular shape and has a pair of lugs on each of a two sides.

7. The removable storage tub for a marine vessel in accordance with claim 6 in which each of said tub plurality of sides has a pair of lugs thereon.

8. The removable storage tub for a marine vessel in accordance with claim 5 in which said hatch frame has a generally rectangular opening having a pair of notches on each of a two sides.

9. The removable storage tub for a marine vessel in accordance with claim 8 in which each side of said hatch frame plurality of sides has a pair of lugs thereon.

10. The removable storage tub for a marine vessel in accordance with claim 5 in which said hatch frame has a hatch door hingedly attached thereto for closing said hatch.
